(19) United States
(12) Patent Application Publication
(10) Pub. No.: US 2011/0300978 A1
(43) Pub. Date: Dec. 8, 2011

(54) TIMING PULLEY

(75) Inventor: Hiroshi SAKAMOTO, Osaka (JP)

(73) Assignee: TSUBAKIMOTO CHAIN CO., Osaka (JP)

(21) Appl. No.: 13/118,316

(22) Filed: May 27, 2011

(30) Foreign Application Priority Data
Jun. 4, 2010 (JP) 2010-128965

(51) Int. Cl. F16H 55/12; F16H 55/17

(52) U.S. Cl. 474/162; 474/152

(57) ABSTRACT

There is provided a timing pulley whose noise is low, which is light-weight, whose pulley structure is simple and which excels in workability. The timing pulley comprises a cylindrical timing hub which is fitted around a power transmitting shaft, a pair of flange members provided apart on both end portions of the timing hub and a plurality of engagement pins disposed on peripheral edge portions of the pair of flange members in the circumferential direction thereof so as to extend between and through each of the flange members and so as to engage with mating teeth of a timing belt.

### CROSS REFERENCE TO RELATED APPLICATIONS

This application claims the foreign priority benefit under Title 35, United States Code, §119 (a)-(d) of Japanese Patent Application No. 2010-128965, filed on Jun. 4, 2010 in the Japan Patent Office, the disclosure of which is herein incorporated by reference in its entirety.

### BACKGROUND OF THE INVENTION

1. Field of the Invention

The present invention relates to a motion transmitting mechanism for transmitting rotational movement by means of a timing belt and more specifically to a timing pulley used together with the timing belt.

2. Related Art

Hitherto, a rotational motion transmitting mechanism comprising a toothed belt such as a timing belt and a timing pulley has been used as a convenient and reliable motion transmitting means which have been used in various applications such as driving an engine auxiliary machine.

The motion transmitting mechanisms often include a toothed belt in which mating teeth are formed on an inner peripheral surface thereof and a timing pulley having mating portions formed so as to engage with the mating teeth formed in the toothed belt. In some configurations, there is a groove-like concavo-convex portion provided in each mating portion in parallel with an axial direction to reduce the area in which each mating tooth of the toothed belt contacts the mating portion of the timing pulley in order to reduce adhesive sound between the toothed belt and the timing pulley or to discharge air remaining in the mating portion to the outside via the concavo-convex portion in order to eliminate air from being compressed at the mating portion and to prevent noise from being generated. One example of such a configuration is disclosed in Japanese Patent Application Laid-open No. H10-141479 Gazette.

Because the mating tooth of the toothed belt and the mating portion of the timing pulley of these configurations have a unique shape, e.g., having an involute curve so that the toothed belt engages smoothly with the timing pulley for a long period of time, the process of fabricating the toothed belt and the timing pulley, i.e., workability, is inefficient because special machining tools and special skill are required.

More specifically, as shown in FIGS. 8 through 10, a substantially entire inner surface of each mating portion 501 formed on a timing pulley 500 (or a sprocket) mates with each mating tooth TB1 of a timing belt TB in the prior art timing belt system. Because this mating portion 501 has a unique and complicated shape, e.g., the involute curve so as not to generate interaction with a surface of the mating tooth TB1 of the timing belt TB as much as possible, the design requires that specialized machine tools such as a hobbing machine and other complicated manufacturing processes are required to fabricate the belt and the pulley.

Additionally, there is also a problem in that the timing pulley 500 often generates noise because air remaining near the bottom of each mating portion 501 is compressed when the timing belt TB engages with the timing pulley 500.

It is conceivable to form the timing pulley 500 so that the air in the mating portion 501 formed on the timing pulley 500 escapes quickly to the outside when engaging with the timing belt TB so that no compression of air occurs near the bottom of the mating portion 501 in order to prevent the noise caused by the compression of air between the timing belt TB and the timing pulley 500 as disclosed in Japanese Patent Application Laid-open No. H6-300116 Gazette. In this case, while a structure such as a groove or a concavo-convex portion for allowing the air to escape to the outside is provided either in the mating tooth TB1 of the timing belt TB or the mating portion of the timing pulley 500, there is a problem that it requires another labor in forming such mechanism.

### BRIEF SUMMARY OF THE INVENTION

Accordingly, the present invention aims at solving the aforementioned prior art problems by providing a timing pulley with reduced noise, a light-weight design, resulting in a pulley structure which is simple and which excels in workability.

In order to solve the aforementioned problems, a first aspect of the invention is a timing pulley which includes a cylindrical timing hub which is fitted around a power transmitting shaft, a pair of flange members provided apart on both end portions of the timing hub, and a plurality of engagement pins disposed on peripheral edge portions of the pair of flange members in a circumferential direction thereof so as to extend between and through each of the flange members and so as to engage with mating teeth of a timing belt.

According to a second aspect of the invention, the engagement pins are attached to the flange members removably through pin inserting holes disposed along the circumferential direction of the flange members.

According to a third aspect of the invention, the flange members are removably fixed to the timing hub by means of a bolt fastening means.

According to a fourth aspect of the invention, the engagement pin is provided with screw portions that are screwed though the flange members with nuts on both sides thereof, respectively.

According to a fifth aspect of the invention, the engagement pin is provided with pin locking small diameter portions by which the engagement pin is locked to the flange members by stop rings on the both sides thereof.

According to a sixth aspect of the invention, the engagement pins are arrayed in the circumferential direction of the flange member so that unit pitches formed between adjacent engagement pins are formed with differentiating intervals in a predetermined order in the circumferential direction.

A seventh aspect of the invention is a motion transmitting mechanism including a power transmitting shaft, a timing belt including mating teeth, and a timing pulley which includes a cylindrical timing hub which is fitted around the power transmitting shaft, a pair of flange members provided apart on both end portions of the timing hub, and a plurality of engagement pins disposed on peripheral edge portions of the pair of flange members in a circumferential direction thereof so as to extend between and through each of the flange members and so as to engage with the mating teeth of the timing belt.

According to a eighth aspect of the invention, the engagement pins are attached to the flange members removably through pin inserting holes disposed along the circumferential direction of the flange members.

According to a ninth aspect of the invention, the flange members are removably fixed to the timing hub by means of a bolt fastening means.

According to a tenth aspect of the invention, the engagement pin is provided with screw portions that are screwed though the flange members with nuts on both sides thereof, respectively.

According to an eleventh aspect of the invention, the engagement pin is provided with pin locking small diameter portions by which the engagement pin is locked to the flange members by stop rings on the both sides thereof.

According to a twelfth aspect of the invention, the engagement pins are arrayed in the circumferential direction of the flange member so that unit pitches formed between adjacent engagement pins are formed with differentiating intervals in a predetermined order in the circumferential direction.

According to the first aspect of the timing pulley of the invention and the seventh aspect of the motion transmitting mechanism, because the timing pulley includes the cylindrical timing hub which is fitted around a power transmitting shaft, the pair of flange members provided apart on the both end portions of the timing hub and the plurality of engagement pins disposed on the peripheral edge portion of the pair of flange members in the circumferential direction thereof so as to extend between and through each of the flange members and so as to engage with the mating teeth of the timing belt, it is possible to provide a timing pulley whose weight is light, whose pulley structure is simple and which excels in workability. In addition, the timing pulley has the following advantageous effects peculiar to the present invention.

That is, because the timing pulley of the first and seventh aspects of the invention includes the plurality of engagement pins disposed on the peripheral edge portions of the pair of flange members in the circumferential direction thereof so as to extend between and through each of the flange members and so as to engage with the mating teeth of the timing belt, and because each mating portion mating with the mating tooth of the timing belt is only the engagement pin and the part inside of the engagement pin is a space opened to the outside, it becomes possible to reduce its weight as compared to a solid timing pulley currently known in the art. It is also possible to eliminate noise otherwise caused by compression of air generated in a closed space because such closed space between the mating portion of the timing pulley and the mating tooth of the timing belt is eliminated.

Still more, because each mating portion of the timing pulley can be made by using the engagement pin that can be fabricated easily, it becomes unnecessary to fabricate the timing pulley by using such machine tool as a hobbing machine and to considerably improve productivity in fabricating the timing pulley.

According to the second aspect of the timing pulley of the invention and the eighth aspect of the motion transmitting mechanism, because the engagement pins are attached to the flange members removably through the pin inserting holes disposed along the circumferential direction of the flange members, it becomes easier to attach the engagement pins and to simplify a timing pulley fabricating process.

Still more, even if a part of the timing pulley is broken, it is unnecessary to replace the entire timing pulley and a damaged timing pulley can be repaired by merely replacing the very engagement pin. Accordingly, it becomes easy to maintain the timing pulley and to reduce waste of its material.

According to the third aspect of the timing pulley of the invention and the ninth aspect of the motion transmitting mechanism, because the flange members are removably fixed to the timing hub by using the bolt fastening means, it becomes unnecessary to perform such cumbersome works as using a hobbing machine in the timing pulley fabricating process because the timing hub and the flange members can be built easily by the bolt fastening means.

According to the fourth aspect of the timing pulley of the invention and the tenth aspect of the motion transmitting mechanism, because the engagement pin is provided with screw portions that are screwed through the flange members with nuts on both sides thereof, respectively, it is possible to attach and remove by screwing and removing the nuts. Accordingly, it becomes possible to fix the timing pulley tightly to the flange members and to simplify such maintenance works as replacement of the engagement pin.

According to the fifth aspect of the of timing pulley of the invention and the eleventh aspect of the motion transmitting mechanism, because the engagement pin is provided with pin locking small diameter portions by which the engagement pin is locked to the flange members by stop rings on the both sides thereof, the engagement pin can be attached to the flange member just by fitting the stop ring to the pin locking small diameter portion of the engagement pin. Accordingly, the work for attaching the engagement pin to the right and left flange members can be simplified.

According to the sixth aspect of the timing pulley of the invention and the twelfth aspect of the motion transmitting mechanism, because the engagement pins are arrayed in the circumferential direction of the flange member with different unit pitches between adjacent engagement pins, it becomes possible to reduce resonant vibrations otherwise occurring as a result of the periodic interaction and to considerably reduce noises caused by that.

### BRIEF DESCRIPTION OF DRAWINGS

FIG. 1 is a schematic view of a timing pulley according to a first embodiment of the invention;

FIG. 2 is a front view of the timing pulley shown in FIG. 1;

FIG. 3 is a section view of the timing pulley taken along a line A-A in FIG. 2;

FIG. 4 is a partially enlarged view of a engagement pin attaching part shown in FIG. 3;

FIG. 5 is a partially enlarged view showing a different mode of the engagement pin attaching part;

FIG. 6 is an explanatory view explaining operations of the timing pulley shown in FIG. 1;

FIG. 7 is an explanatory view explaining operations of a timing pulley of a second embodiment of the invention;

FIG. 8 is a front view of a prior art timing pulley;

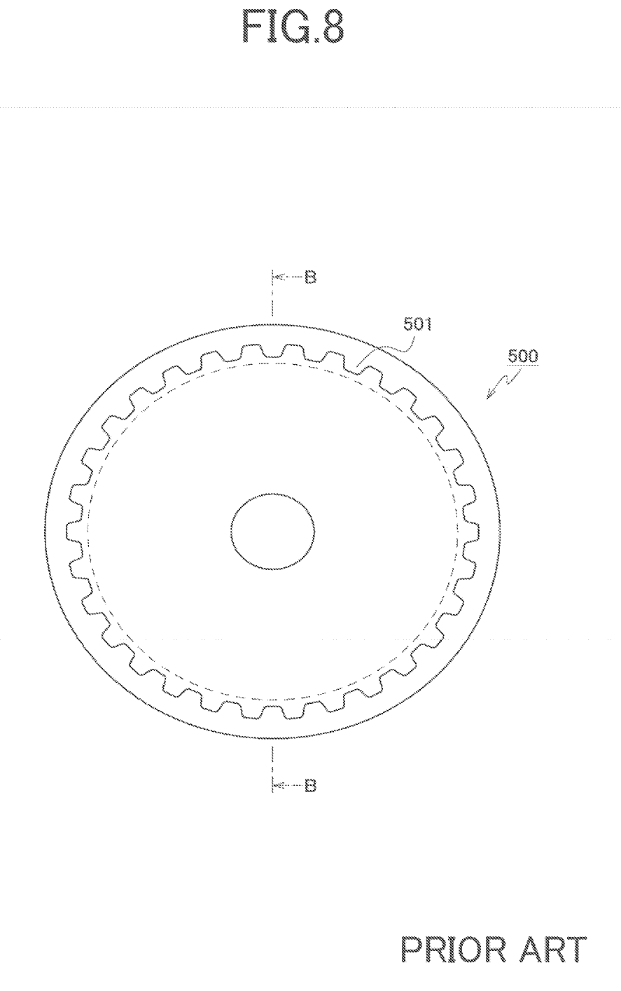

FIG. 9 is a section view of the prior art timing pulley taken along a line B-B in FIG. 8; and

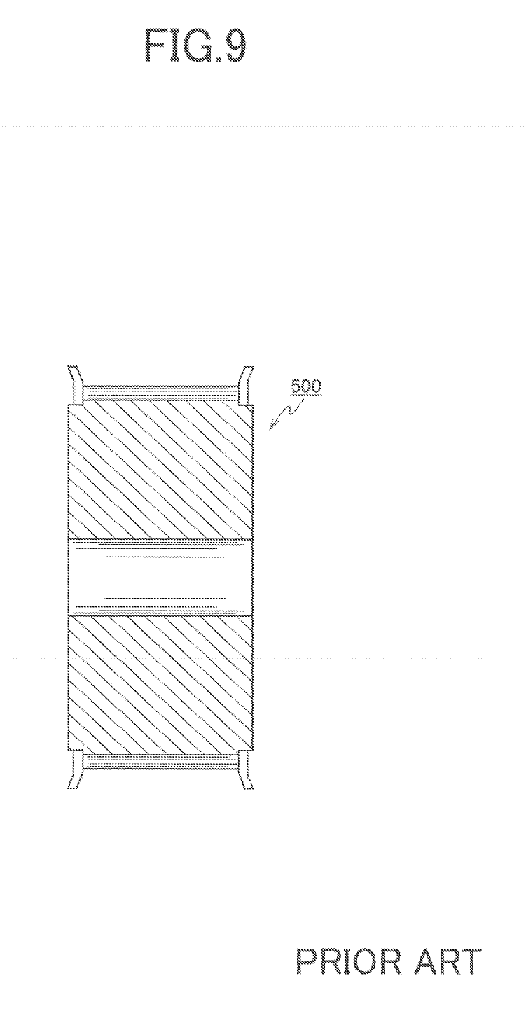

FIG. 10 is an explanatory view explaining operations of the prior art timing pulley.

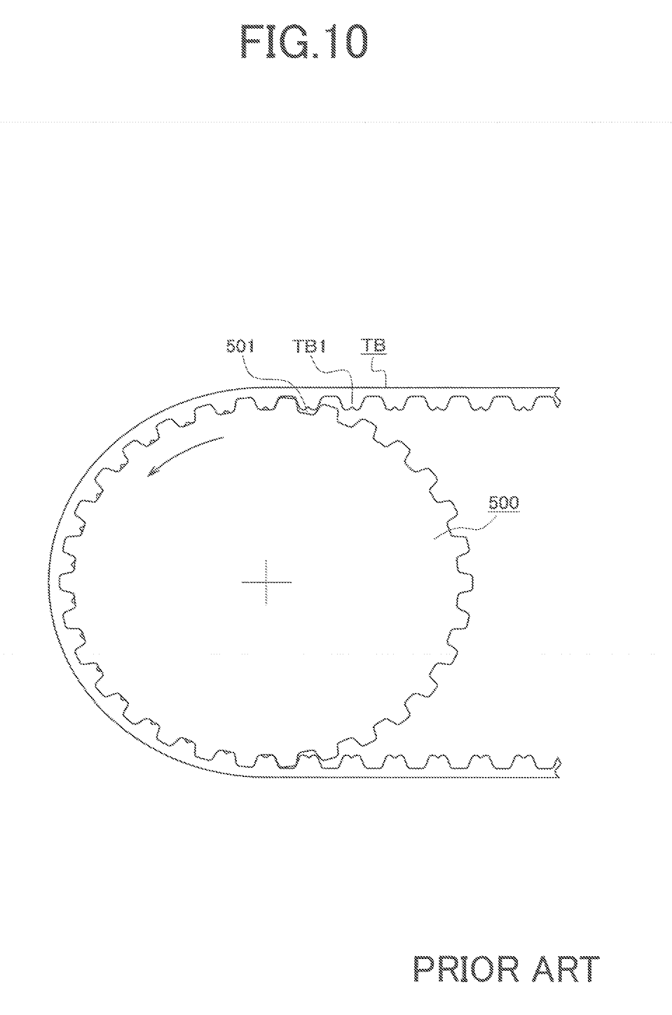

### BEST MODE FOR CARRYING OUT THE INVENTION

### First Embodiment

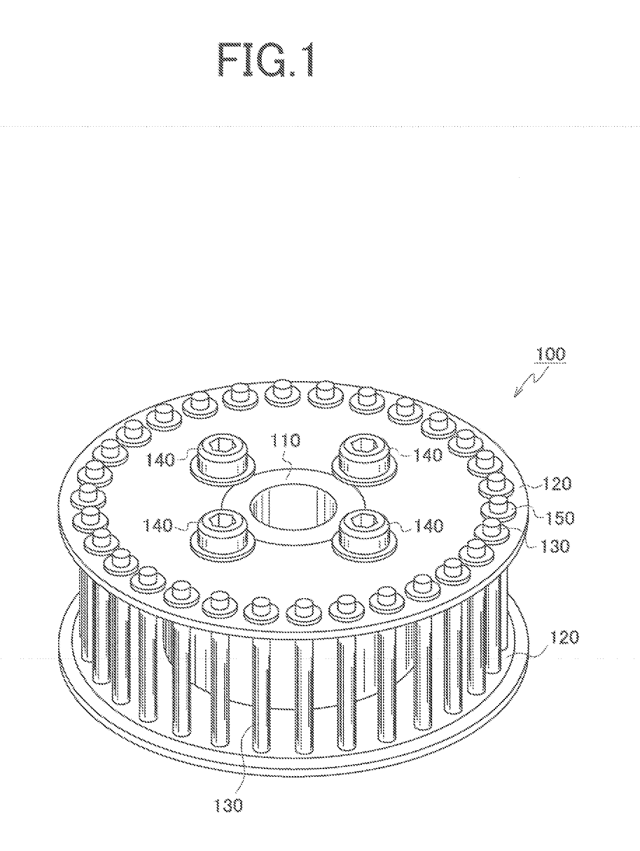

A first embodiment of a timing pulley of the invention will be explained with reference to FIGS. 1 through 6.

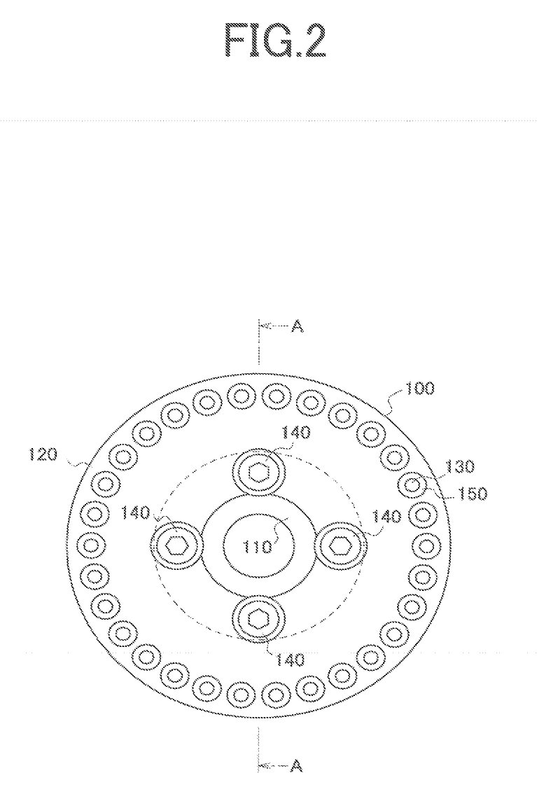

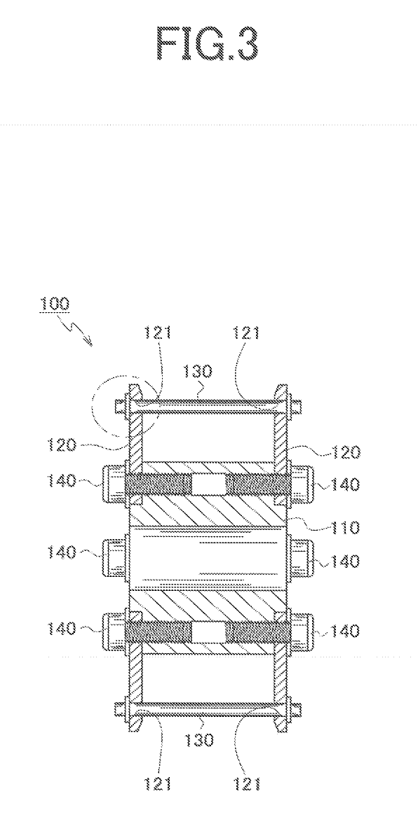

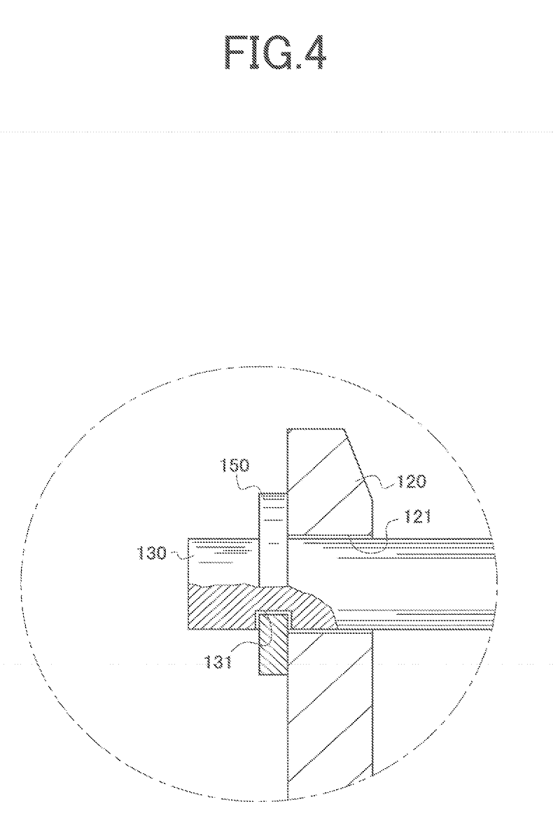

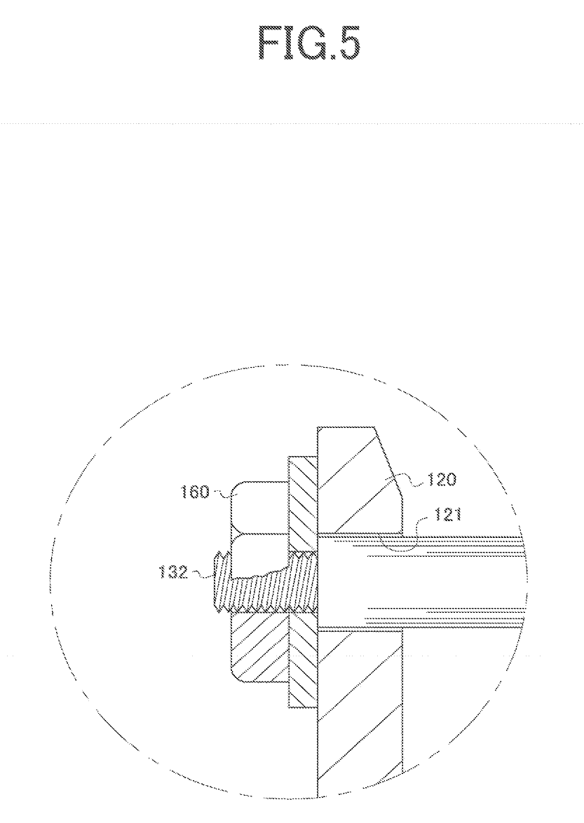

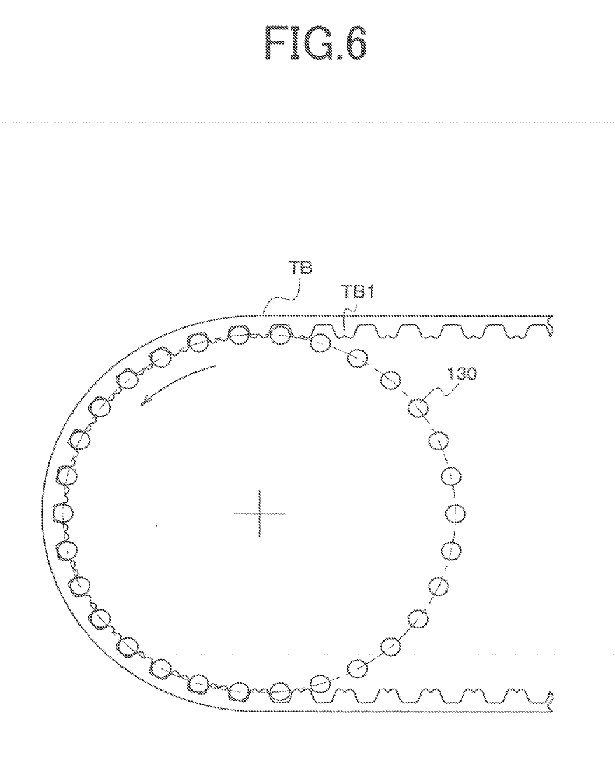

Here, FIG. 1 is a schematic view of the timing pulley of the first embodiment, FIG. 2 is a front view of the timing pulley shown in FIG. 1, FIG. 3 is a section view of the timing pulley shown in FIG. 2, FIG. 4 is a partially enlarged view of an engagement pin attaching part shown in FIG. 3, FIG. 5 is a partially enlarged view showing a different mode of the engagement pin attaching part shown in FIG. 3 and FIG. 6 is an explanatory view explaining operations of the timing pulley shown in FIG. 1.

The timing pulley 100 of the first embodiment of the invention is used in a timing belt system which may be used in a variety of settings, such as driving an engine auxiliary device for example.

The timing pulley 100 comprises a cylindrical and metallic timing hub 110 which is fitted around a power transmitting shaft. Then, circular flange members 120 are provided on both sides in an axial direction of the timing hub 110 removably by four bolts 140, respectively.

Engagement pins 130 are disposed so as to extend between and through each of the pair of flange members 120 provided on the both sides of the timing hub 110. As shown in FIGS. 2 and 3, the engagement pins 130 are removably inserted through a plurality of pin inserting holes 121 disposed in a circumferential direction of peripheral edge portions of the pair of flange members 120, respectively. As shown in FIG. 4, each engagement pin 130 is cylindrically-shaped as a whole and is provided with slit-shaped pin locking small diameter portions 131 around both ends thereof corresponding to a width of each flange member 120 in the present embodiment. Each engagement pin 130 can be attached to the flange member 120 by inserting the pin 130 through the pin inserting hole 121 from either of the pair of flange members 120 and by locking the engagement pin 130 by fitting stop rings 150 to the pin locking small diameter portions 131 provided on the both ends of the engagement pin 130 when the both end thereof project out of the both sides of the pair of flange members 120.

It is noted that while the engagement pin 130 is locked to the flange member 120 by the stop ring 150 as shown in FIG. 4, it is also possible to provide screw portions 132 on the both ends of the engagement pin 130 as shown in FIG. 5 as another mode for attaching the engagement pin 130. The engagement pin 130 is attached to the flange member 120 by inserting the engagement pin 130 from either of the pair of flange members 120 and by fastening and fixing nuts 160 to the screw portions 132 on the both ends of the engagement pin 130 when the both ends of the engagement pin 130 project out of the both sides of the pair of flange members 120.

The engagement pin 130 can be tightly fixed to the flange member 120 and looseness of the engagement pin 130 in the pin inserting hole 121 can be eliminated by fastening the engagement pin 130 by thus using the nuts 160.

The timing belt TB wound around the timing pulley 100 can be made from the same synthetic resin as is coated around core wires known in the prior art. The timing belt TB is provided, on an inner surface thereof, with mating teeth TB1 that mate with the engagement pins 130 of the timing pulley 100.

As shown in FIG. 6, the timing pulley 100 is used by winding the timing belt TB around its outer periphery. The mating teeth TB1 of the timing belt TB engage between the front and rear engagement pins 130 and transmit power reliably.

An important characteristic of the first embodiment is that the only spot where the timing pulley 100 contacts the mating teeth TB1 of the timing belt TB is at the side surfaces of the cylindrical engagement pins 130 provided around the circumference of the timing pulley 100. That is, only the cylindrical surfaces of the engagement pins 130 mate with the mating teeth TB1 of the timing belt TB such that the parts between the engagement pins 130 and inside of the engagement pin 130s in the timing pulley 100 are vacant spaces where only the flange members 120 exist. The spots which come into contact with the timing belt TB are made by fabricating the cylindrical engagement pins 130 and by attaching them between and so that they extend through the flange members 120.

Still more, because no closed space is formed between the surface of the mating tooth TB1 of the timing belt TB and the mating portion of the timing pulley 100, unlike the prior art timing belt system, the phenomenon of compression of air that has occurred in the mating portion of the prior art timing belt system does not occur.

The timing pulley 100 of the first embodiment thus obtained has the cylindrical timing hub 110 which is fitted around the power transmitting shaft, the pair of flange members 120 provided apart on the both end portions of the timing hub 110 and the plurality of engagement pins 130 disposed on the peripheral edge portion of the pair of flange members 120 in the circumferential direction thereof so as to extend between and through each of the flange members and so as to engage with the mating teeth TB1 of the timing belt TB, so that the timing pulley 100 becomes free from noise otherwise caused by the compression of air generated at the part mating with the timing belt like the prior art timing pulley 500, and can have the light-weight pulley structure as compared to the prior art timing pulley using a heavy timing pulley.

Still more, because the timing pulley 100 can be fabricated by assembling using only parts having the simple shapes and structures like the timing hub 110, the flange members 120 and the engagement pins 130, its fabrication process can be considerably simplified as compared to the prior art timing pulley fabricated by implementing various machining such as forging and cutting on a metallic material. Thus, the advantageous effects of the first embodiment of the timing pulley of the invention are remarkable.

### Second Embodiment

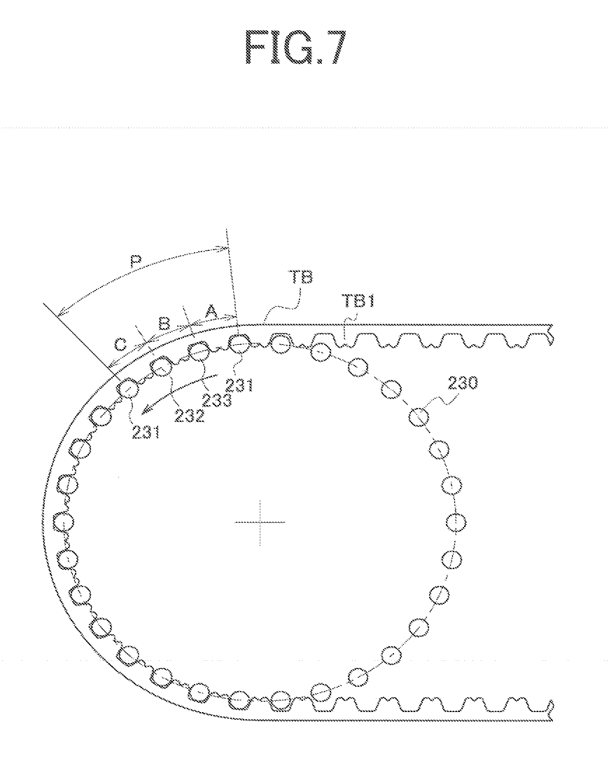

Next, a timing pulley 200 according to a second embodiment of the invention will be explained with reference to FIG. 7.

The timing pulley of the second embodiment is different from the first embodiment only in the mode for attaching the engagement pins 130 and other components are the same with those of the second embodiment, so that an overlapped explanation of members of the second embodiment with those of the timing pulley 100 of the first embodiment will be omitted here by denoting reference numerals in 200s.

FIG. 7 is an explanatory view explaining operations of the timing pulley of the second embodiment of the invention. The timing pulley 200 of the second embodiment forms one unit pitch P by three engagement pins 230 for example. More specifically, an interval A is formed between the engagement pins 231 and 232, an interval B is formed between the engagement pins 232 and 233 and an interval C is formed between the engagement pins 233 and a next engagement pin 231. The unit pitch P is formed by the distance between four adjacent engagement pins 230 wherein the three intervals between each of the four adjacent engagement pins 230 are different from each other. The timing pulley 200 is composed of the unit pitches P arrayed in the circumferential direction.

The intervals of the engagement pins 230 are arranged as described above in the timing pulley 200 of the second embodiment, so that regularity of the interaction between the engagement pins 230 and the timing belt TB is broken and resonant vibrations of the timing belt TB are considerably reduced.

Specifically, the problem of the resonant vibrations described above can be eliminated just by arranging the simple measure of appropriately changing the intervals in the circumferential direction of the engagement pins 230 attached to the flange member 220.

It is noted that although the three types of intervals of the engagement pins 231 through 233 are formed in the timing pulley 200 of the second embodiment, the arrangement of the intervals is not limited to three and the unit pitch P can be formed by providing four or more intervals by four or more engagement pins 230.

Still more, it is possible to arrange variously so as to give irregularity to the engagement structure between the engagement pins 230 and the mating teeth TB1 not only by changing the intervals by which the engagement pins 230 are disposed but also appropriately changing diameters and shapes of the engagement pins 230 in the circumferential direction as long as such arrangement eliminates periodicity in the interaction between the timing pulley 200 and the timing belt TB.

According to the timing pulley 200 of the second embodiment thus obtained, the engagement pins 230 are arrayed in the circumferential direction of the pair of flange members 220 so that the unit pitches P between adjacent engagement pins 230 are differentiated according to a predetermined order in the circumferential direction. As described above, the timing pulley 200 has the cylindrical timing hub 210 which is fitted around the power transmitting shaft, the pair of flange members 220 provided apart on the both end portions of the timing hub 210 and the plurality of engagement pins 230 disposed on the peripheral edge portion of the pair of flange members 220 in the circumferential direction thereof so as to extend between and through each of the flange members and so as to engage with the mating teeth TB1 of the timing belt TB.

Accordingly, the timing pulley 200 of the second embodiment can considerably reduce noise otherwise caused by the resonant vibrations of the timing belt TB, in addition to the advantageous effects brought about by the timing pulley 100 of the first embodiment.

Still more, because the mechanism for eliminating the resonant vibrations of the timing belt TB can be achieved with the simple method of just changing the intervals of the engagement pins 230 in the circumferential direction, it becomes possible to simplify the fabrication process and to considerably improve workability thereof. Thus, the advantageous effects of the second embodiment of the timing pulley of the invention are remarkable.

The specific mode of the timing pulley of the present invention may take any mode as long as the timing pulley includes the cylindrical timing hub which is fitted around a power transmitting shaft, the pair of flange members provided apart on the both end portions of the timing hub and the plurality of engagement pins disposed on the peripheral edge portions of the pair of flange members in the circumferential direction thereof so as to extend between and through each of the flange members and so as to engage with the mating teeth of the timing belt. As described above, one advantage of the embodiments described herein is a timing pulley whose noise is low, whose weight is reduced, whose pulley structure is simple and which excels in workability.

That is, while materials of the timing hub, flange members or engagement pins composing the timing pulley can be metal as is known in the prior art, those parts can be formed of also synthetic resin materials such as FRP, engineering plastics and others corresponding strength required for the motion transmitting mechanism or can be a combination of metallic parts and synthetic resin parts.

Still more, the timing belt used together with the timing pulley can be formed of a similar material with what used in the prior art and may be a synthetic resin reinforced by filamentary materials such as steel wires and Kevlar fiber.

Furthermore, any means can be adopted as the bolt fastening means as long as it is capable of firmly fastening the engagement pin.

What is claimed is:

1. A timing pulley comprising:
a cylindrical timing hub which is fitted around a power transmitting shaft;
a pair of flange members provided apart on both end portions of said timing hub, and
a plurality of engagement pins disposed on peripheral edge portions of said pair of flange members in a circumferential direction thereof so as to extend between and through each of said flange members and so as to engage with mating teeth of a timing belt.

2. The timing pulley according to claim 1, wherein said engagement pins are attached to said flange members removably through pin inserting holes disposed along the circumferential direction of said flange members.

3. The timing pulley according to claim 1, wherein said flange members are removably fixed to said timing hub by means of a bolt fastening means.

4. The timing pulley according to claim 1, wherein each of said engagement pin is provided with screw portions that are screwed to said flange members through nuts on both sides thereof, respectively.

5. The timing pulley according to claim 1, wherein each of said engagement pin is provided with pin locking small diameter portions by which said engagement pin is locked to said flange members by means of stop rings on the both sides thereof.

6. The timing pulley according to claim 1, wherein said engagement pins are arrayed in the circumferential direction of said flange member so that unit pitches between adjacent engagement pins are disposed so as to have differentiating intervals in a predetermined order serially in the circumferential direction.

7. A motion transmitting mechanism comprising:
a power transmitting shaft;
a timing belt including a plurality of mating teeth; and
a timing pulley including:
a cylindrical timing hub which is fitted around the power transmitting shaft;
a pair of flange members provided at both end portions of said timing hub having a cylindrical shape, and
a plurality of engagement pins disposed along an outer circumference of the said pair of flange members, the engagement pins being disposed in a space between the said flange members and being adapted so as to extend through an inserting hole of each of said flange members, the engagement pins engaging with the mating teeth of a timing belt as the timing pulley is driven as the power transmitting shaft is rotated.

8. The motion transmitting mechanism according to claim 7, wherein said engagement pins are attached to said flange members removably through pin inserting holes disposed along the circumferential direction of said flange members.

9. The motion transmitting mechanism according to claim 7, wherein said flange members are removably fixed to said timing hub by means of a bolt fastening means.

10. The motion transmitting mechanism according to claim 7, wherein each of said engagement pin is provided with screw portions that are screwed to said flange members through nuts on both sides thereof, respectively.

11. The motion transmitting mechanism according to claim 7, wherein each of said engagement pin is provided with pin locking small diameter portions by which said engagement pin is locked to said flange members by means of stop rings on the both sides thereof.

12. The motion transmitting mechanism according to claim 7, wherein said engagement pins are arrayed in the circumferential direction of said flange member so that unit pitches between adjacent engagement pins are disposed so as to have differentiating intervals in a predetermined order serially in the circumferential direction.
